(19) United States
(12) Patent Application Publication
(10) Pub. No.: US 2024/0135192 A1
(43) Pub. Date: Apr. 25, 2024

(54) ZONE GRADIENT DIFFUSION (ZGD) FOR ZONE-BASED FEDERATED LEARNING

(71) Applicant: QUALCOMM Incorporated, San Diego, CA (US)

(72) Inventors: Vijaya Datta MAYYURI, San Diego, CA (US); An CHEN, San Diego, CA (US)

(21) Appl. No.: 18/461,410

(22) Filed: Sep. 4, 2023

Related U.S. Application Data
(60) Provisional application No. 63/418,454, filed on Oct. 21, 2022.

(51) Int. Cl. G06N 3/098

(52) U.S. Cl. CPC G06N 3/098

(57) ABSTRACT

A processor-implemented method includes receiving machine learning model updates from clients in a federated learning system. The method also includes determining a fixed local zone associated with each of the clients, the fixed local zone having a first fixed boundary. The method includes updating model weights of a central machine learning model based on local machine learning updates for a local subset of the clients corresponding to the fixed local zone. The method includes updating the model weights of the central machine learning model based on neighbor machine learning updates for a neighbor subset of the clients. The neighbor subset corresponds to a fixed neighbor zone that neighbors the fixed local zone and has a second fixed boundary. The neighbor machine learning updates have a different weight than the local machine learning updates when updating model weights. A value of the different weight corresponds to a similarity parameter.

### CROSS-REFERENCE TO RELATED APPLICATION

The present application claims the benefit of U.S. Provisional Patent Application No. 63/418,454, filed on Oct. 21, 2022, and titled “ZONE GRADIENT DIFFUSION (ZGD) FOR ZONE BASED FEDERATED LEARNING,” the disclosure of which is expressly incorporated by reference in its entirety.

### FIELD OF THE DISCLOSURE

The present disclosure relates generally to wireless communications, and more specifically to zone gradient diffusion (ZGD) techniques for zone-based federated learning.

### BACKGROUND

Federated learning is a machine learning technique that trains a federated learning model across multiple decentralized edge devices or servers holding local data samples, without sharing the data samples with a central server. Federated learning provides benefits of privacy preserving machine learning and continuous learning on the edge. However, the performance of federated learning suffers when the data at the devices is non-independent and identically distributed (non-IID). Data augmentation is one approach to address the non-IID data. Another approach is zone-based federated learning.

Zone-based federated learning groups participating devices into zones, which helps with non-IID data distribution at the edge. Data from devices outside the zone of interest may be relevant, however. If the zone boundaries are not flexible, those relevant model updates will be ignored. Techniques for capturing relevant neighboring device information would be desirable.

### SUMMARY

In aspects of the present disclosure, a processor-implemented method includes receiving machine learning model updates from a number of clients in a federated learning system. The method also includes determining a fixed local zone associated with each of the clients the fixed local zone having a first fixed boundary. The method further includes updating model weights of a central machine learning model based on local machine learning updates for a local subset of the clients. The local subset corresponds to the fixed local zone. The method also includes updating the model weights of the central machine learning model based on neighbor machine learning updates for a neighbor subset of the clients. The neighbor subset corresponds to a fixed neighbor zone that neighbors the fixed local zone. The neighbor machine learning updates have a different weight than the local machine learning updates when updating model weights. A value of the different weight corresponds to a similarity parameter, the fixed neighbor zone having a second fixed boundary.

Other aspects of the present disclosure are directed to an apparatus. The apparatus has at least one memory and one or more processors coupled to the at least one memory. The processor(s) is configured to receive machine learning model updates from a number of clients in a federated learning system. The processor(s) is also configured to determine a fixed local zone associated with each of the clients the fixed local zone having a first fixed boundary. The processor(s) is further configured to update model weights of a central machine learning model based on local machine learning updates for a local subset of the clients. The local subset corresponds to the fixed local zone. The processor(s) is also configured to update the model weights of the central machine learning model based on neighbor machine learning updates for a neighbor subset of the clients. The neighbor subset corresponds to a fixed neighbor zone that neighbors the fixed local zone. The neighbor machine learning updates have a different weight than the local machine learning updates when updating model weights. A value of the different weight corresponds to a similarity parameter, the fixed neighbor zone having a second fixed boundary.

Other aspects of the present disclosure are directed to an apparatus. The apparatus includes means for receiving machine learning model updates from a number of clients in a federated learning system. The apparatus also includes means for determining a fixed local zone associated with each of the clients the fixed local zone having a first fixed boundary. The apparatus further includes means for updating model weights of a central machine learning model based on local machine learning updates for a local subset of the clients. The local subset corresponds to the fixed local zone. The apparatus also includes means for updating the model weights of the central machine learning model based on neighbor machine learning updates for a neighbor subset of the clients. The neighbor subset corresponds to a fixed neighbor zone that neighbors the fixed local zone. The neighbor machine learning updates have a different weight than the local machine learning updates when updating model weights. A value of the different weight corresponds to a similarity parameter, the fixed neighbor zone having a second fixed boundary.

In other aspects of the present disclosure, a non-transitory computer-readable medium with program code recorded thereon is disclosed. The program code is executed by a processor and includes program code to receive machine learning model updates from clients in a federated learning system. The program code also includes program code to determine a fixed zone associated with each of the clients the fixed local zone having a first fixed boundary. The program code further includes program code to update model weights of a central machine learning model based on local machine learning updates for a local subset of the clients. The local subset corresponds to the fixed local zone. The program code also includes program code to update the model weights of the central machine learning model based on neighbor machine learning updates for a neighbor subset of the clients. The neighbor subset corresponds to a fixed neighbor zone that neighbors the fixed local zone. The neighbor machine learning updates have a different weight than the local machine learning updates when updating model weights. A value of the different weight corresponds to a similarity parameter, the fixed neighbor zone having a second fixed boundary.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 illustrates an example implementation of designing a neural network using a system-on-a-chip (SOC), including a general-purpose processor, in accordance with certain aspects of the present disclosure.

FIG. 5 is a block diagram illustrating an exemplary deep convolutional network (DCN), in accordance with various aspects of the present disclosure.

FIG. 6 is a diagram illustrating an example of different zones in a federated learning system, in accordance with various aspects of the present disclosure.

FIG. 7 is a diagram illustrating an example zone network topology for zone-based federated learning, in accordance with various aspects of the present disclosure.

FIG. 8 is a block diagram illustrating an example of a participating device including a federated learning (FL) manager, in accordance with various aspects of the present disclosure.

FIG. 9 is a timeline illustrating zone membership checking, in accordance with various aspects of the present disclosure.

FIG. 10 is a diagram illustrating exemplary pseudocode for implementing zone gradient diffusion, in accordance with various aspects of the present disclosure.

FIG. 11 is a flow diagram illustrating an example process performed, for example, by a federated learning device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Federated learning is a machine learning technique that trains a machine learning model across multiple decentralized edge devices or servers holding local data samples, without sharing the data samples with a central server. Federated learning provides benefits of privacy preserving machine learning and continuous learning on the edge. However, the performance of federated learning suffers when the data at the devices is non-independent and identically distributed (non-IID). Data augmentation is one approach to address the non-IID data. Another approach is zone-based federated learning.

Zone-based federated learning groups participating devices into zones, which helps with non-IID data distribution at the edge. Data from devices outside the zone of interest may be relevant, however. If the zone boundaries are not flexible, those relevant model updates will be ignored. Aspects of the present disclosure include a method of accounting for machine learning updates (or gradients) of devices from neighboring zones, in addition to machine learning updates (or gradients) from local devices in the zone corresponding to the local machine learning model being updated. In these aspects, the centralized server considers machine learning updates (or gradients) from neighbor zones, in addition to the local machine learning updates (or gradients) from the zone of interest, when updating the model weights of the local machine learning model for the zone of interest. The degree to which the neighbor machine learning weights influence the model for the zone of interest may be learned over time.

Particular aspects of the subject matter described in this disclosure can be implemented to realize one or more of the following potential advantages. In some examples, the described techniques, such as updating model weights based on local and neighbor machine learning updates may improve a zone model by aggregating contextual information derived from local gradients of neighboring zones.

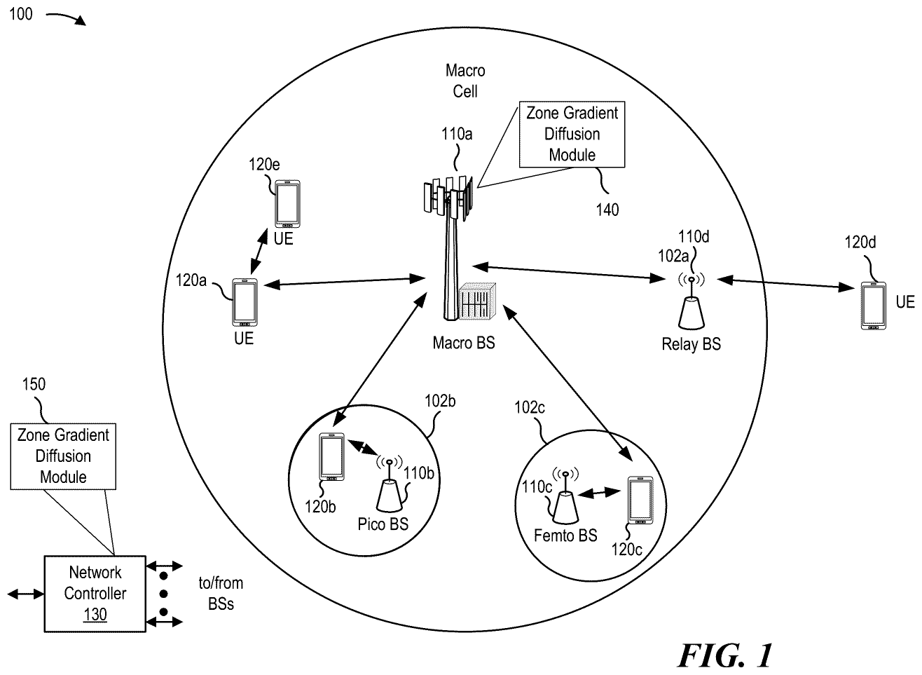

FIG. 1 is a diagram illustrating a network 100 in which aspects of the present disclosure may be practiced. The network 100 may be a 5G or NR network or some other wireless network, such as an LTE network. The wireless network 100 may include a number of BS s 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B, an access point, a transmit and receive point (TRP), a network node, a network entity, and/or the like. A BS can be implemented as an aggregated base station, as a disaggregated base station, an integrated access and backhaul (IAB) node, a relay node, a sidelink node, etc. The BS can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. The network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

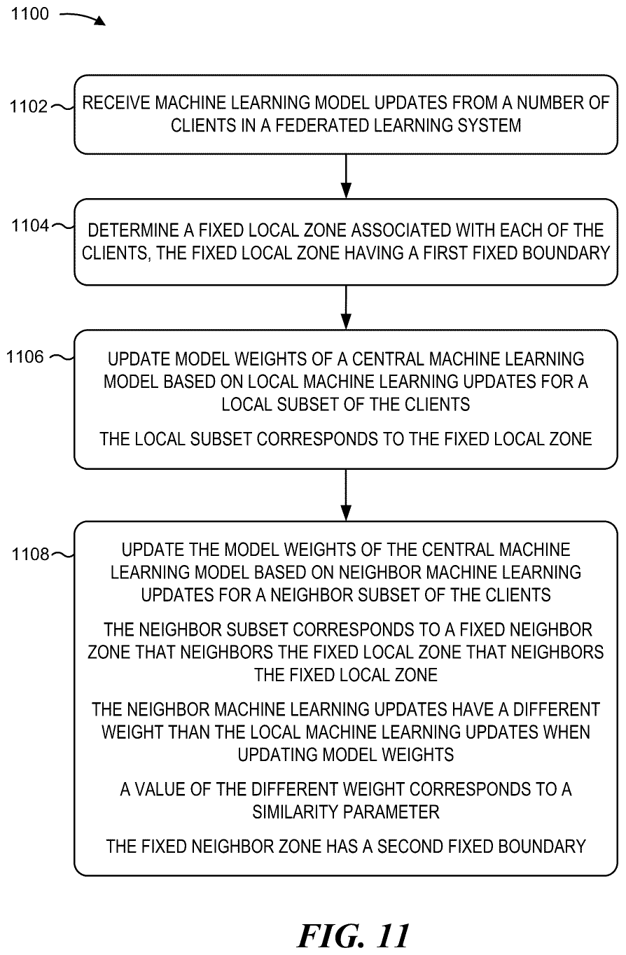

The base station 110 may include a zone gradient diffusion module 140. The network controller 130 may also or alternatively include a zone gradient diffusion module 150. The zone gradient diffusion module 140, 150 may perform various functions, such as one or more of the elements of the process 1100 described with reference to FIG. 11.

As indicated above, FIG. 1 is provided merely as an example. Other examples may differ from what is described with regard to FIG. 1.

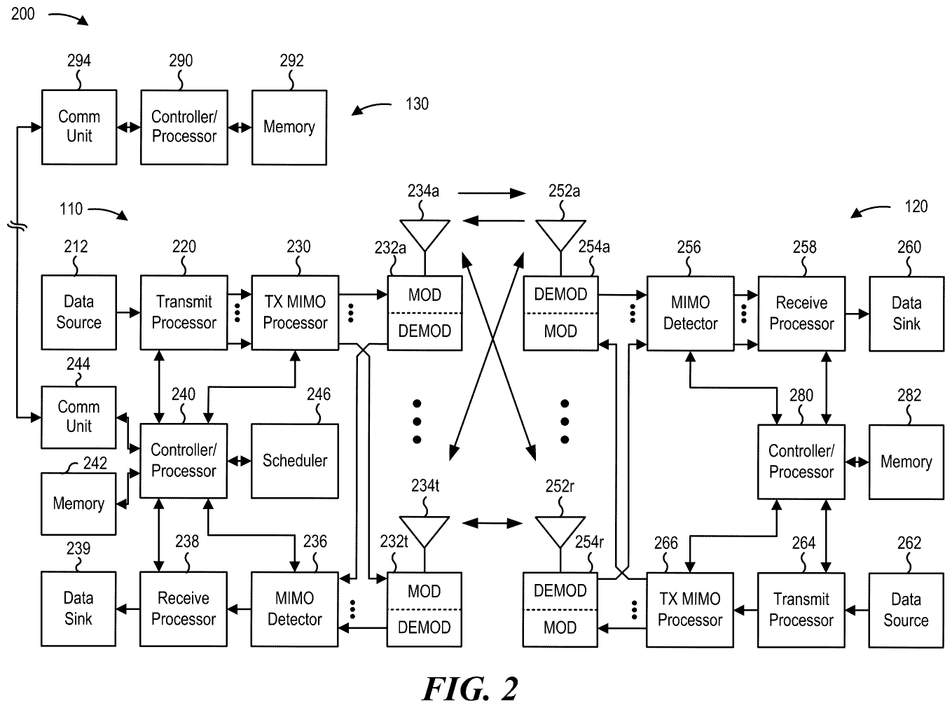

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the network controller 130 via the communications unit 244. The network controller 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with zone-based gradient diffusion, as described in more detail elsewhere. For example, the controller/processor 240 of the base station 110, the controller/processor 280 of the UE 120, and/or any other component(s) of FIG. 2 may perform or direct operations of, for example, the processes of FIG. 11 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for receiving, means for determining, means for updating, and means for learning. In some aspects, the base station 110 may include means for transmitting, means for determining, means for updating, and means for learning. Such means may include one or more components of the UE 120 or base station 110 described in connection with FIG. 2.

As indicated above, FIG. 2 is provided merely as an example. Other examples may differ from what is described with regard to FIG. 2.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

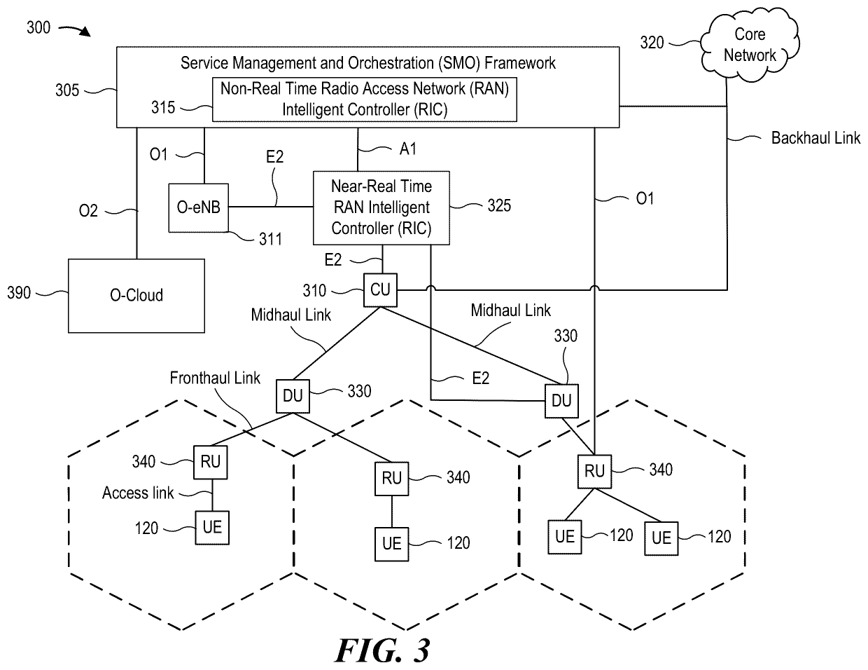

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via O1) or via creation of RAN management policies (such as A1 policies).

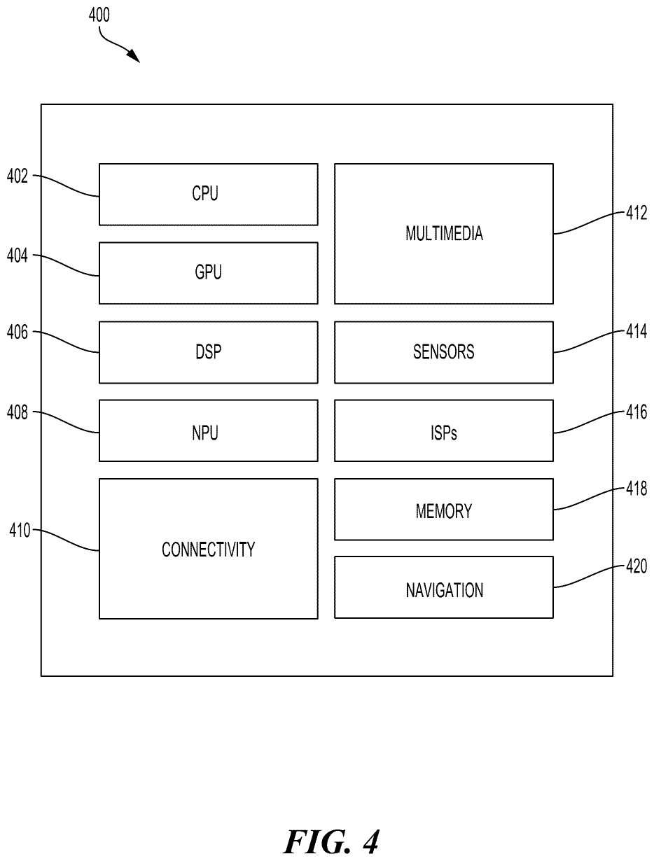

FIG. 4 illustrates an example implementation of a system-on-a-chip (SOC) 400, which may include a central processing unit (CPU) 402 or a multi-core CPU configured for zone gradient diffusion, in accordance with certain aspects of the present disclosure. The SOC 400 may be included in the base station 110 or UE 120. Variables (e.g., neural signals and synaptic weights), system parameters associated with a computational device (e.g., neural network with weights), delays, frequency bin information, and task information may be stored in a memory block associated with a neural processing unit (NPU) 408, in a memory block associated with a CPU 402, in a memory block associated with a graphics processing unit (GPU) 404, in a memory block associated with a digital signal processor (DSP) 406, in a memory block 418, or may be distributed across multiple blocks. Instructions executed at the CPU 402 may be loaded from a program memory associated with the CPU 402 or may be loaded from a memory block 418.

The SOC 400 may also include additional processing blocks tailored to specific functions, such as a GPU 404, a DSP 406, a connectivity block 410, which may include fifth generation (5G) connectivity, fourth generation long term evolution (4G LTE) connectivity, Wi-Fi connectivity, USB connectivity, Bluetooth connectivity, and the like, and a multimedia processor 412 that may, for example, detect and recognize gestures. In one implementation, the NPU is implemented in the CPU, DSP, and/or GPU. The SOC 400 may also include a sensor processor 414, image signal processors (ISPs) 416, and/or navigation module 420, which may include a global positioning system.

The SOC 400 may be based on an ARM instruction set. In aspects of the present disclosure, the instructions loaded into the general-purpose processor 402 may comprise code to receive machine learning model updates from a number of clients in a federated learning system. The instructions may also comprise code to determine a fixed local zone associated with each of the clients, the fixed local zone having a first fixed boundary. The instructions may further comprise code to update model weights of a central machine learning model based on local machine learning updates for a local subset of the clients, the local subset corresponding to the fixed local zone. The instructions may also comprise code to update the model weights of the central machine learning model based on neighbor machine learning updates for a neighbor subset of the clients. The neighbor subset corresponds to a fixed neighbor zone that neighbors the fixed local zone. The neighbor machine learning updates have a different weight than the local machine learning updates when updating model weights. A value of the different weight corresponds to a similarity parameter, the fixed neighbor zone having a second fixed boundary.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

Connections between layers of a neural network may be fully connected or locally connected. To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map receiving input from a range of neurons in the previous layer and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

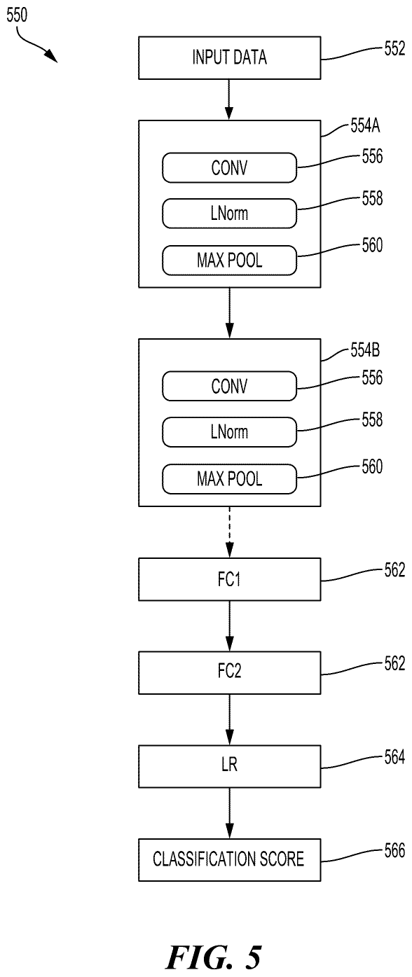

FIG. 5 is a block diagram illustrating a DCN 550. The DCN 550 may include multiple different types of layers based on connectivity and weight sharing. As shown in FIG. 5, the DCN 550 includes the convolution blocks 554A, 554B. Each of the convolution blocks 554A, 554B may be configured with a convolution layer (CONV) 556, a normalization layer (LNorm) 558, and a max pooling layer (MAX POOL) 560.

Although only two of the convolution blocks 554A, 554B are shown, the present disclosure is not so limiting, and instead, any number of the convolution blocks 554A, 554B may be included in the DCN 550 according to design preference.

The convolution layers 556 may include one or more convolutional filters, which may be applied to the input data to generate a feature map. The normalization layer 558 may normalize the output of the convolution filters. For example, the normalization layer 558 may provide whitening or lateral inhibition. The max pooling layer 560 may provide down sampling aggregation over space for local invariance and dimensionality reduction.

The parallel filter banks, for example, of a deep convolutional network may be loaded on a CPU 402 or GPU 404 of an SOC 400 (e.g., FIG. 4) to achieve high performance and low power consumption. In alternative embodiments, the parallel filter banks may be loaded on the DSP 406 or an ISP 416 of an SOC 400. In addition, the DCN 550 may access other processing blocks that may be present on the SOC 400, such as sensor processor 414 and navigation module 420, dedicated, respectively, to sensors and navigation.

The DCN 550 may also include one or more fully connected layers 562 (FC1 and FC2). The DCN 550 may further include a logistic regression (LR) layer 564. Between each layer 556, 558, 560, 562, 564 of the DCN 550 are weights (not shown) that are to be updated. The output of each of the layers (e.g., 556, 558, 560, 562, 564) may serve as an input of a succeeding one of the layers (e.g., 556, 558, 560, 562, 564) in the DCN 550 to learn hierarchical feature representations from input data 552 (e.g., images, audio, video, sensor data and/or other input data) supplied at the first of the convolution blocks 554A. The output of the DCN 550 is a classification score 566 for the input data 552. The classification score 566 may be a set of probabilities, where each probability is the probability of the input data, including a feature from a set of features.

Federated learning is a machine learning technique that trains a federated learning model across multiple decentralized edge devices or servers holding local data samples, without sharing the data samples with a central server. Federated learning provides benefits of privacy preserving machine learning and continuous learning on the edge. However, the performance of federated learning suffers when the data at the devices is non-independent and identically distributed (non-IID). Data augmentation is one approach to address the non-IID data. Another approach is zone-based federated learning.

Zone-based federated learning groups participating devices into zones, which helps with non-IID data distribution at the edge. Data from devices outside the zone of interest may be relevant, however. If the zone boundaries are not flexible, those relevant model updates will be ignored. Aspects of the present disclosure introduce a method of accounting for machine learning updates (or gradients) of devices from neighboring zones, in addition to machine learning updates (or gradients) from devices in the zone corresponding to the machine learning model being updated. In these aspects, the centralized server considers machine learning updates (or gradients) from neighbor zones, in addition to the local machine learning updates (or gradients), when updating the model weights of the local machine learning model. The degree to which the neighbor machine learning weights influence the local model for the zone of interest may be learned over time.

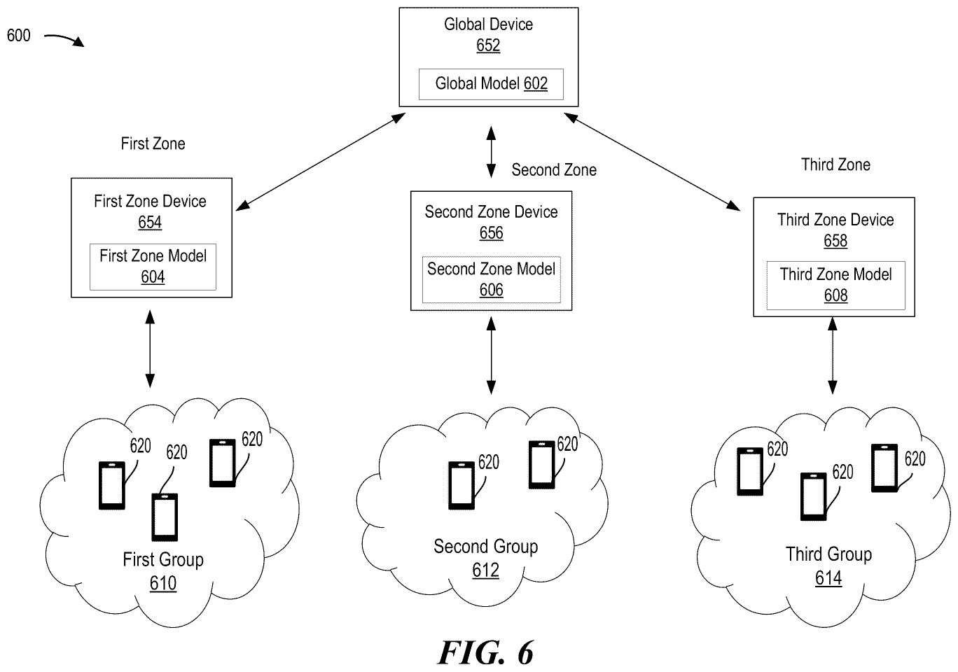

FIG. 6 is a diagram illustrating an example 600 of different zones in a federated learning system, in accordance with various aspects of the present disclosure. In the example 600 of FIG. 6, each UE 620 may be an example of a device participating in federated learning. Such devices may be referred to as participating devices. Additionally, each UE 620 may be an example of a UE 120 as described with reference to FIGS. 1 and 2. In some implementations, as shown in the example 600 of FIG. 6, each UE 620 may be placed in a group 610, 612, 614 based on one or more common attributes or settings. Each group 610, 612, 614 may correspond to a particular zone. For example, as shown in FIG. 6, a first group 610 corresponds to a first zone, a second group 612 corresponds to a second zone, and a third group 614 corresponds to a third zone. In some examples, a UE 620 may be placed in more than one group 610, 612, 614 (not shown in FIG. 6). Additionally, or alternatively, two or more zones may overlap (not shown in FIG. 6). As described, the attributes and settings may include, but are not limited to, a geographic location, a default language, or a user interface theme. As an example, each group 610, 612, 614 may be based on a UE's geographic location. In this example, the UEs 620 in a first group 610 have a common geographic location, the UEs 620 in a second group 612 have a common geographic location, and the UEs 620 in a third group 614 have a common geographic location.

Additionally, as shown in FIG. 6, each group 610, 612, 614 may be associated with a different zone server 654, 656, 658, where each zone server 654, 656, 658 stores a different zone model 604, 606, 608. A zone server may also be referred to as a zone device. The zone models 604, 606, 606 may be examples of machine learning models, such as deep neural networks. Each zone server 654, 656, 658 may be a different network device, such as a federated learning (FL) server. In some examples, each zone server 654, 656, 658 may be integrated with a base station, such as a base station 110 of FIGS. 1 and 2, or a backend server device, such as the network controller 130 of FIGS. 1 and 2. As described, each zone model 604, 606, 608 may be customized based on training performed at the participating devices of a corresponding group 610, 612, 614. Furthermore, as shown in FIG. 6, each zone model 604, 606, 608 may be associated with a global model 602 stored in a global server 652, such as a network device (e.g., server). The global server 652 may be in a same location as one or more of the zone server 654, 656, 658. Alternatively, each device 652, 654, 656, 658 may be in a different geographic location. As described, each zone model 604, 606, 608 may be customized based on training performed at UEs 620 of an associated group.

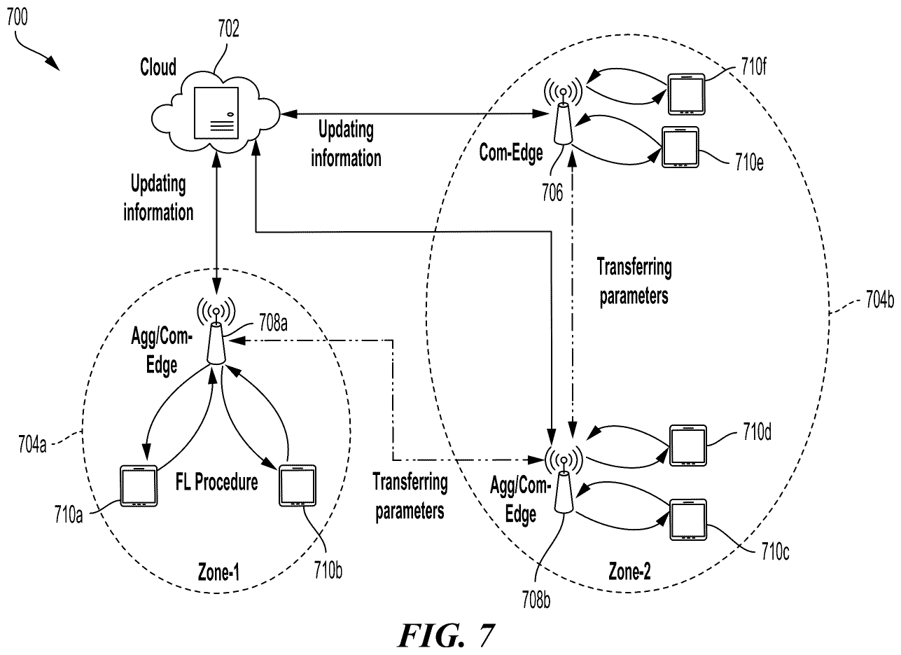

FIG. 7 is a diagram illustrating an example zone network topology for zone-based federated learning, in accordance with various aspects of the present disclosure. In FIG. 7, the example zone network topology 700 includes two zones, zone 1 704a, and zone 2 704b. For brevity and ease of illustration, only two zones are shown, however, the zone network topology may include more than two zones. Each of the zones 704a, 704b may include multiple participating devices 710a-710f. Each of the participating devices 710a-710f may be a mobile communication device such as a smartphone or an electric vehicle, or an Internet of Things (IoT) device, for example. Each of the participating devices may be included in a group corresponding to a zone (e.g., 704a or 704b) based on one or more common attributes or settings. In some examples, a participating device (e.g., 710a-710f) may be a member of more than one group (not shown in FIG. 7). Additionally, or alternatively, two or more zones may overlap (not shown in FIG. 7). As described, the attributes and settings may include, but are not limited to, a geographic location, a default language, or a user interface theme. As an example, each zone 704a or 704b may be based on a geographic location of the participating devices 710a-710f.

Each of the participating devices 710a-710f may interface and communicate with one or more communicator edge nodes (e.g., 706, 708a, and 708b). In some aspects, a communicator edge node (e.g., 706, 708a and 708b) may also act as an aggregator for a given zone. An aggregator may be configured to perform zone level federated averaging. That is, the aggregator may receive model updates computed at each of the participating devices (e.g., 710a-710f) for a zone (e.g., 704a or 704b) and may compute a representative value, such as an average, for that zone. For instance, the communicator edge node 708a may also serve as an aggregator for zone-1 704a. On the other hand, the communicator edge node 708b may also serve as an aggregator for zone-2 704b. In some aspects, the communicator edge nodes (e.g., 706, 708a, and 708b) and the aggregator nodes may be a base station (e.g., gNode B). For example, in 5G NR and later deployments, mobile edge compute (MEC) devices may serve as an aggregator (e.g., 708a, 708b) or communicator (e.g., 706, 708a, and 708b).

Each zone (e.g., 704a, 704b) may include one or more communicator edge nodes (e.g., 706) and an aggregator (e.g., 708a, 708b) that also operates as a communicator edge node. The aggregator (e.g., 708a, 708b) may receive a global model from the cloud device 702. The aggregator (e.g., 708a, 708b) may distribute the global model to each of the participating devices (e.g., 710a-710f) in the zone. Each of the participating devices (e.g., 710a-710f) may be trained with the global model to produce a local model. As each device (e.g., 710a-710f) may collect data and operate the local model, each of the participating devices may be re-trained (e.g., according to a loss function) to produce a local model update. Each of the aggregators (e.g., 708a, 708b) may receive the local model update from the devices (e.g., 710a-710f) in respective zones. For instance, the aggregator 708a may receive a local model update from devices 710a and 710b. The aggregator 708a may aggregate the local model updates and compute a zone-model update, for example, using a federated averaging process. The aggregator (e.g., 708a) may then supply the zone-model update to each of the participating devices (e.g., 710a-710b) in the zone. In addition, the aggregator (e.g., 708a, 708b) may supply the zone-model update to the cloud device 702, which manages the global model. The updates may include all model weights, model weights that have changed, delta values of model weights, or in some cases, the entire model.

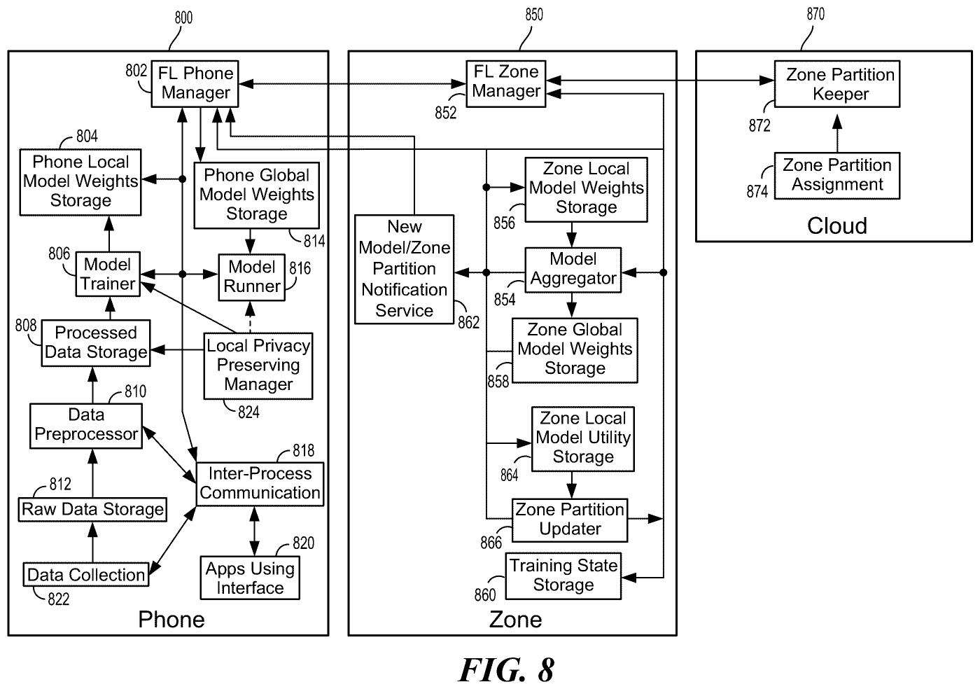

FIG. 8 is a block diagram illustrating an example of a participating device 800 including a federated learning (FL) manager 802, in accordance with various aspects of the present disclosure. In the example of FIG. 8, the participating device 800 may be an example of a UE, such as a UE 120, 710 as described with reference to FIGS. 1, 2, 3, and 7, respectively. The participating device 800 may communicate with at least a network device in a zone 850, including a federated learning zone manager 852 (only one network device with zone manager shown). The network device in each zone 850 may be an example of a base station 110, such as a base station 110, 706, 708 as described with reference to FIGS. 1, 2, 3, and 7, respectively. The network device in the zone 850 including the federated learning zone manager 852 may communicate with a network device in a cloud 870 including a zone partition keeper 872. The network device in the cloud 870 with the zone partition keeper 872 may be an example of a cloud device 702, as described with reference to FIG. 7, or the network controller 130, as described with reference to FIGS. 1 and 2, but is not so limited.

As shown in FIG. 8, the participating device 800 may include multiple components, such as a local weight storage 804, a global weight storage 814, a model trainer 806, a model runner 816, a processed data storage 808, a data preprocessor 810, a raw data storage 812, an inter-process communication component 818, a data collector 822, and a local privacy preserving manager 824. The various storage components 804, 806, 808, 812, 814 may be different partitions or storage locations in a same storage device, such as the memory 282 as described with reference to FIG. 2. In another example, the storage components 804, 806, 808, 812, 814 may be different storage devices. An inter-process communication component 818, such as a bus or a controller/processor, may facilitate communication between the different components 804, 806, 808, 810, 812, 814, 816. The inter-process communication component 818 may be an example of the controller/processor 280 as described with reference to FIG. 2. The ‘apps’ 820 represent an interface (e.g., an application programming interface (API)) that may be used by applications (e.g., third party applications) to communicate with the FL phone manager 802 and related components 802, 804, 806, 808, 810, 812, 814, 816, 818, 822, 824 in order to participate in federated training, or to run inference by a model managed by the FL phone manager 802.

In some examples, a federated learning (FL) manager 802 controls data collection using one or more data collectors 822. Each data collector 822 may collect data from a sensor (not shown in FIG. 8) at a sampling rate. In some implementations, a data collector 822 may be embedded with another data collector 822, such that both data collectors 822 simultaneously collect different types of data. Controlling the data collection via the FL manager 802 may improve resource use, such as battery use and/or processor use, because the FL manager 802 may prevent multiple data collectors 822 from collecting the same data. Additionally, sensor access control may be simplified based on the FL manager 802 controlling the data collection. In some examples, the FL manager 802 may dynamically (e.g., on-demand) configure one or more of sensor types, sampling rates, and a period for flushing data from memory (not shown in FIG. 8) to storage, such as processed data storage 808. Each model may inform the FL manager 802 of the type of data it needs for training and a specified sampling rate. Based on the information provided by each model, the FL manager 802 may identify the appropriate data collectors 822 to invoke and a corresponding sampling rate. In some implementations, the FL manager 802 may use one or more policies to balance sensing accuracy (e.g., a sampling rate) with resource consumption (e.g., battery use, process load, etc.).

In the example of FIG. 8, the data collectors 822 store data obtained from one or more sensors (not shown in FIG. 8) in the raw data storage 812. Additionally, the data collectors 822 may inform the FL manager 802 when new data is added to the raw data storage 812. In some examples, the data collectors 822 may buffer a certain amount of sensed data in memory before committing the sensed data to the raw data storage 812. The FL manager 802 may dynamically reconfigure the data flushing period that defines when the data is written to the raw data storage 812. In such examples, the data flushing period may be initially set by the data collectors 822.

In some examples, a model may use the raw data. In other examples, a model may specify additional processing for the raw data. The additional processing may be performed by a data processor 810. Although not shown in FIG. 8, the device 800 may include one or more data processors 810. Additionally, one or more data processors 810 may be model-specific. In some examples, the FL manager 802 may determine when to invoke the model-specific data processors 810. Each data processor 810 may store data in the processed data storage 808. The data may be stored at an interval or based on new data becoming available in the raw data storage 812. In some examples, all data is pre-processed before initiating a new local model training operation.

In some examples, the data processor 810 and data collectors 822 may be implemented by third-party developers. In some such examples, the FL manager 802 may use an inter-process communication (IPC) component 818 function provided by the phone's operating system to interact with third-party components.

As described, the FL manager 802 may initiate a model trainer for a given model and determine a location of the data in the processed data storage 808 or raw data storage 812. After the training is completed, the model trainer 806 may store the newly computed weights in the local weight storage 804. Additionally, the FL manager 802 may determine when the stored weights may be uploaded to a network device.

In some examples, the FL manager 802 may receive multiple models from one or more zone managers 852. That is, multiple models (e.g., federated learning models or applications) may be provided to the participating device 800. As an example, a first application may be a text prediction model and a second application may be a location based advertising model. In such examples, the FL manager 802 may determine a training time for each model. In some examples, the participating device 800 may be associated with two different zone managers, where each zone server is associated with a different zone. Each zone server may transmit a different model. As another example, a single zone server may transmit two or more different zone models.

The models may be stored in the model trainer 806. Local weights of each model may be stored in the local weight storage 804 and global weights may be stored in the global weight storage 814. In some implementations, the FL manager 802 may work in conjunction with one or more components 804, 806, 808, 810, 812, 814, 816 of the participating device 800 to determine a training priority of the various models stored in the model trainer 806. In some examples, a priority of the model may be determined based on various criteria, such as, but not limited to, one or more of a number of samples available for training for a given model, a current accuracy of the model, an estimated model training time determined based on previous training times, and whether the training can be successfully completed based on current resources availability (e.g., battery levels, current system load, etc.). Additionally, the FL manager 802 may manage a local training state of the various models stored in the model trainer 806. As an example, the FL manager 802 may stop training a first model and start training a second model. In such an example, the FL manager 802 may store the local weights of the first model in the local weight storage 804 to maintain the training state of the first model, such that the training may resume at a later time.

In some implementations, the FL manager 802 may determine current device resources to assess whether one or more models may be locally trained (e.g., trained on-device). It may be desirable to locally train the model to preserve data privacy. Still, local training may be limited because the participating device 800, such as UEs and edge-devices, may have a limited amount of resources. In such implementations, the FL manager 802 may use a local privacy preserving manager 824 if the current device resources satisfy a resource condition and a current connectivity state satisfies a connection condition.

As described, an amount of available resources, such as available memory or processer load, may prevent the participating device 800 from locally training a model. In this example, the resource condition may be satisfied when an amount of available resources prevents local training. That is, the amount of available resources may be less than a threshold. In some examples, the FL manager 802 may determine the current connectivity state when the resource condition is satisfied. The connectivity state refers to a connection status between the participating device 800 and a network device over a communication channel, such as a Wi-Fi channel or a cellular channel. In such an example, the connection condition may be satisfied if the participating device can communicate with a network device, such as an inter-network or intra-network device, over a communication channel. In this example, the FL manager 802 may use the network device as a proxy for training the model.

In some implementations, a local privacy preserving manager 824 may be individually controlled by each participating device 800 to improve training speed while still preserving privacy. The local privacy preserving manager 824 may be a network device that may receive both a model and training data. The network device may train the model and return the trained weights and biases to the participating device. In some examples, the local privacy preserving manager 824 may delete data corresponding to the model, weights, and biases after the training session. Furthermore, in some examples, the local privacy preserving manager 824 may not understand an overall context of the model. Rather, the local privacy preserving manager 824 may only be responsible for training the model. Additionally, a global server may be unaware of the local privacy preserving manager 824. Because of the decentralized nature of training, and because the local privacy preserving manager 824 is unaware of the overall context, the privacy of the participating device may be preserved.

The zone partition keeper 872 communicates with each federated learning zone manager 852. The zone partition keeper 872 includes a zone partition assignment module 874 that maintains the overall zone topology graph. The overall zone topology graph identifies the zones and the zone managers 852 for each zone.

The federated learning zone managers 852 are responsible for communicating with the participating devices 800, such as smartphones, and performing zone level aggregation. The federated learning zone manager 852 also interacts with the neighbors to perform merge or split operations, and update the latest zone partition information to the zone partition keeper 872. The zones may adapt to improve overall model accuracy.

In some aspects of the present disclosure, the FL zone manager 852 invokes a model aggregator 854 for the model when enough updates have been uploaded or when a training round timer expires. The model aggregator 854 reads the updates from a zone local model weights storage 856, computes the aggregated weights, and stores them in a zone global model weights storage 858. An intermediate training state is stored in a training state storage 860 to provide lower input/output (I/O) latency compared with other types of cloud storage in the design. This is because the FL zone manager 852 needs frequent access to the data during training. Next, the model aggregator 854 sends a notification via a new model notification service 862 to let the participating devices 800 know that a new model version is available. A zone local model utility storage 864 and a zone partition updater 866 are used for model validation and zone management.

When a device 800 registers to participate in federated learning, the device 800 is provided with the latest zone topology graph along with a “zone determination function.” This function accepts a set of parameters from the device and returns the zone information to which the device belongs. The parameters may include global positioning system (GPS) coordinates, for example. The function may run offline and may be local to each device 800.

The device 800 periodically checks its zone membership and tabulates its training data based on the zone membership. When the device 800 is ready to perform local training, the device 800 communicates with the federated learning zone managers 852 for the zones to which the device belongs/belonged. Whenever there is a change to the zone topology or the zone determination function, the zone partition keeper 872 updates and notifies all the participating devices 800.

In other aspects, the device stores training data along with parameters that are used by the zone membership function. For example, if trying to train a Human-activity-recognition (HAR) model using sensor data, and if the zone-partition keeper provides a zone determination function that accepts GPS coordinates as a parameter, then the device may store the raw sensor data along with GPS information in a sequential or time stamped manner. When the device is ready to perform local training, the device may use the GPS data included in the data samples to determine for which zone this data will be used. These aspects differ from the prior approach in that the device determines the zone membership as the data is being collected and then tabulates the data, in the prior approach. The previously described approach involves a periodic lookup of zone membership. In the second approach, the device collects the training data along with the parameters used to determine zone membership. The data is partitioned to match the zones at a later point in time.

Zone membership checking may be performed periodically or in an event driven manner. According to aspects of the present disclosure, the device stores locally generated training, test, and validation data to reflect the zone in which the data was collected. The zone determination function may be used in offline mode (e.g., not connected to the network). According to aspects of the present disclosure, the device 800 maintains storage, even when not connected to a network (e.g., moving from zone one to zone two). When connectivity resumes, previously stored training weights can be uploaded to the zone one manager, even when the device 800 has moved to a different zone (e.g., zone two).

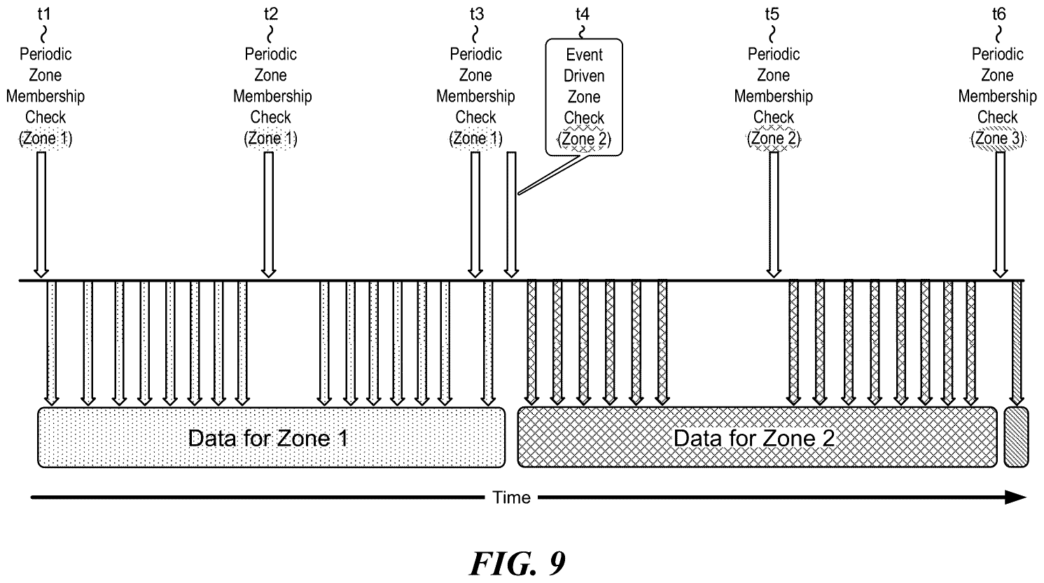

FIG. 9 is a timeline illustrating zone membership checking, in accordance with various aspects of the present disclosure. In the example of FIG. 9, at time t1, the participating device 800 performs a periodic zone membership check using the zone determination function. At time t1, the device 800 determines it is a member of zone one. As a result, the device 800 stores any locally generated training, test, and validation data to reflect the data was collected in zone one. At times t2 and t3, the participating device 800 again performs a periodic zone membership check. At times t2 and t3, the device 800 is still a member of zone one. As a result, the device 800 stores the locally generated data collected at these times (e.g., t2, t3) to reflect the data was collected in zone one.

At time t4, an event driven zone check occurs. For example, a handover or different type of activity based on a sensor may trigger this event driven zone check. An accelerometer is an example of a type of sensor that may trigger the event driven zone check. At time t4, the device 800 determines it is now a member of zone two. Thus, data collected at this time is stored with reference to zone two. At time t5, the device 800 performs another periodic zone check. At time t5, the device 800 is still in zone two and stores data accordingly. At time t6, the periodic zone check indicates the device 800 is now in zone three. As a result, the device 800 stores its data with reference to zone three. Once the device 800 is ready to perform local training, the device 800 communicates with the federated learning zone managers 852 for the zones that it has collected local data. In other words, the device 800 fetches the latest federated learning models for the zones for which the device 800 was a member, and performs local training and uploads model updates.

Zone-based federated learning has advantages when compared to standard federated learning models. In some examples, zone-based federated learning helps handle non-independent and identically distributed (non-IID) or class-unbalanced data in the wild. Additionally, zone-based federated learning aids in customized model evolution. Zone-based federated learning also capitalizes on the idiosyncratic traits of a given region or group of participants.

Identifying optimal zone boundaries for zone-based federated learning can be challenging. Aspects of the present disclosure address the problem when zone boundaries are not properly identified and/or cannot be changed. In many deployments or applications, zones may be defined based on prior-knowledge, e.g., administrative regions, counties, geometric patterns, etc. Simple zone-based model evolution of the zone boundaries may be sub-optimal in some situations.

According to aspects of the present disclosure, when updating the model weights of a given zone “Zᵢ”, at least some of the clients from zone Zᵢ's neighboring zones are included in the training process. The degree to which zone Zᵢ's neighboring zones influence zone Zᵢ's model evolution may be controlled by a self-attention parameter β. The value of β for each neighbor of zone Zᵢ can be learned over time. How many neighboring clients to sample may be determined based on how similar a neighbor zone is to the zone of interest. For example, a neighbor population may be compared with the population of the zone of interest. Such a comparison may help determine which neighbors are most similar.

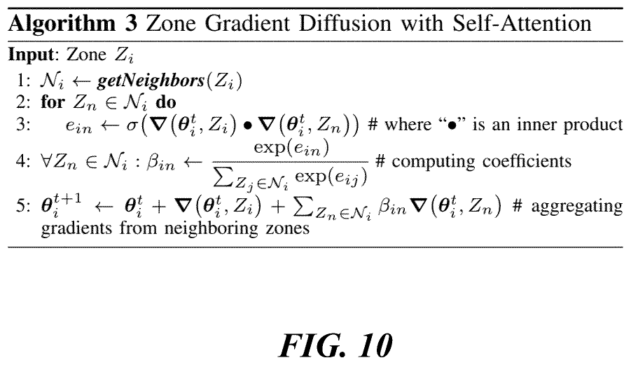

FIG. 10 is a diagram illustrating exemplary pseudocode for implementing zone gradient diffusion, in accordance with various aspects of the present disclosure. In the pseudocode, at line 1, neighbors of a zone Zᵢ are located. At line 2, the process iterates across all neighbor zones Zₙ. The neighboring zones Zₙ are neighbors of the local zone Zᵢ. For each neighbor, a relationship, such as a normalized inner product, between gradients of the neighbor and gradients of the local client is determined at line 3 to obtain a similarity eᵢₙ between gradients of the zones. The present disclosure is not limited to the normalized inner product, as other relationships may also be useful. The symbol σ represents the sigmoid function in line 3, while the symbol θᵢ^{t} represents the model parameters for the zone Zᵢ at training round t. The gradients of a zone Zᵢ are represented as ∇(θᵢ^{t}, Zᵢ) and the gradients of a neighboring zone Z n are represented as ∇(θᵢ^{t}, Zₙ).

At line 4, a similarity parameter ßᵢₙ, such as a self-attention coefficient, is determined for all neighbors based on the formula shown in FIG. 10. The similarity parameter Bin determines which neighbors should be most influential. In line 4, exp represents the exponential function. In line 4, the similarity parameters are computed for all neighbors. The denominator in line 4 is calculated by summing over the counter variable j for all neighbor similarities eᵢⱼ.

At line 5, gradients from neighbor zones are aggregated with local gradients based on the parameter calculated for that neighbor in line 4. In some aspects, the parameter may indicate the neighbors are afforded less weight than the local updates. In other aspects, the parameter indicates more weight should be assigned to the local updates.

Zone gradient diffusion (ZGD) improves a zone model by aggregating contextual information derived from local gradients of neighboring zones. In zone gradient diffusion, the zones do not change, but the user mobility behavior change is captured through the diffusion of information from neighboring zones. A self-attention mechanism is applied in zone gradient diffusion to dynamically quantify the impact of each zone on its neighbors.

FIG. 11 is a flow diagram illustrating an example process 1100 performed, for example, by a federated learning device, in accordance with various aspects of the present disclosure. The example process 1100 is an example of zone gradient diffusion (ZGD) techniques for zone-based federated learning. The operations of process 1100 may be implemented by a network controller 130 and/or a base station 110.

At block 1102, the network controller and/or base station receives machine learning model updates from a number of clients in a federated learning system. For example, the network controller or base station (e.g., using the controller/processor 290, communications unit 294, memory 292, antenna 234, MOD/DEMOD 232, MIMO detector 236, receive processor 238, controller/processor 240, memory 242, and/or the like) may receive machine learning model updates.

At block 1104, the network controller and/or base station determines a fixed local zone associated with each of the number of clients, the fixed local zone having a first fixed boundary. For example, the network controller and/or base station (e.g., using controller/processor 290, memory 292, controller/processor 240, memory 242, and/or the like) may determine the fixed local zone.

At block 1106, the network controller and/or base station updates model weights of a central machine learning model based on local machine learning updates for a local subset of the clients. The local subset corresponds to the fixed local zone. For example, the network controller and/or base station (e.g., using controller/processor 290, memory 292, controller/processor 240, memory 242, and/or the like) may update the model weights.

At block 1108, the network controller and/or base station updates the model weights of the central machine learning model based on neighbor machine learning updates for a neighbor subset of the clients. The neighbor subset corresponds to a fixed neighbor zone that neighbors the fixed local zone. The neighbor machine learning updates have a different weight than the local machine learning updates when updating model weights. A value of the different weight corresponds to a similarity parameter. The fixed neighbor zone has a second fixed boundary. For example, the network controller and/or base station (e.g., using controller/processor 290, memory 292, controller/processor 240, memory 242, and/or the like) may update the model weights. In some aspects, the parameter is learned. The parameter may by a self-attention coefficient, for example that normalizes a relationship between local machine learning updates and neighbor machine learning updates. The relationship may be an inner product, for example.

### Example Aspects

Aspect 1: A processor-implemented method, comprising: receiving machine learning model updates from a plurality of clients in a federated learning system; determining a fixed local zone associated with each of the plurality of clients, the fixed local zone having a first fixed boundary; updating model weights of a central machine learning model based on local machine learning updates for a local subset of the plurality of clients, the local subset corresponding to the fixed local zone; and updating the model weights of the central machine learning model based on neighbor machine learning updates for a neighbor subset of the plurality of clients, the neighbor subset corresponding to a fixed neighbor zone that neighbors the fixed local zone, the neighbor machine learning updates having a different weight than the local machine learning updates when updating model weights, a value of the different weight corresponding to a similarity parameter, the fixed neighbor zone having a second fixed boundary.

Aspect 2: The processor-implemented method of Aspect 1, further comprising learning the similarity parameter with machine learning training.

Aspect 3: The processor-implemented method of Aspect 1 or 2, in which the similarity parameter comprises a self-attention coefficient.

Aspect 4: The processor-implemented method of any of the preceding Aspects, in which the self-attention coefficient normalizes a relationship between the local machine learning updates of the local subset and the neighbor machine learning updates of the neighbor subset.

Aspect 5: The processor-implemented method of any of the preceding Aspects, in which the relationship comprises an inner product.

Aspect 6: An apparatus, comprising: at least one memory; and at least one processor coupled to the at least one memory, the at least one processor configured to: receive machine learning model updates from a plurality of clients in a federated learning system; determine a fixed local zone associated with each of the plurality of clients, the fixed local zone having a first fixed boundary; update model weights of a central machine learning model based on local machine learning updates for a local subset of the plurality of clients, the local subset corresponding to the fixed local zone; and update the model weights of the central machine learning model based on neighbor machine learning updates for a neighbor subset of the plurality of clients, the neighbor subset corresponding to a fixed neighbor zone that neighbors the first zone, the neighbor machine learning updates having a different weight than the local machine learning updates when updating model weights, a value of the different weight corresponding to a similarity parameter, the fixed neighbor zone having a second fixed boundary.

Aspect 7: The apparatus of Aspect 6, in which the at least one processor is further configured to learn the similarity parameter with machine learning training.

Aspect 8: The apparatus of Aspect 6 or 7, in which the similarity parameter comprises a self-attention coefficient.

Aspect 9: The apparatus of any of the Aspects 6-8, in which the self-attention coefficient normalizes a relationship between the local machine learning updates of the local subset and the neighbor machine learning updates of the neighbor subset.

Aspect 10: The apparatus of any of the Aspects 6-9, in which the relationship comprises an inner product.

Aspect 11: An apparatus, comprising: means for receiving machine learning model updates from a plurality of clients in a federated learning system; means for determining a fixed local zone associated with each of the plurality of clients, the fixed local zone having a first fixed boundary; means for updating model weights of a central machine learning model based on local machine learning updates for a local subset of the plurality of clients, the local subset corresponding to the fixed local zone; and means for updating the model weights of the central machine learning model based on neighbor machine learning updates for a neighbor subset of the plurality of clients, the neighbor subset corresponding to a fixed neighbor zone that neighbors the first zone, the neighbor machine learning updates having a different weight than the local machine learning updates when updating model weights, a value of the different weight corresponding to a similarity parameter, the fixed neighbor zone having a second fixed boundary.

Aspect 12: The apparatus of Aspect 11, further comprising means for further comprising learning the similarity parameter with machine learning training.

Aspect 13: The apparatus of Aspect 11 or 12, in which the similarity parameter comprises a self-attention coefficient.

Aspect 14: The apparatus of any of the Aspects 11-13, in which the self-attention coefficient normalizes a relationship between the local machine learning updates of the local subset and the neighbor machine learning updates of the neighbor subset.

Aspect 15: The apparatus of any of the Aspects 11-14, in which the relationship comprises an inner product.

Aspect 16: A non-transitory computer-readable medium having program code recorded thereon, the program code executed by a processor and comprising: program code to receive machine learning model updates from a plurality of clients in a federated learning system; program code to determine a fixed local zone associated with each of the plurality of clients, the fixed local zone having a first fixed boundary; program code to update model weights of a central machine learning model based on local machine learning updates for a local subset of the plurality of clients, the local subset corresponding to fixed local zone; and program code to update the model weights of the central machine learning model based on neighbor machine learning updates for a neighbor subset of the plurality of clients, the neighbor subset corresponding to a fixed neighbor zone that neighbors the first zone, the neighbor machine learning updates having a different weight than the local machine learning updates when updating model weights, a value of the different weight corresponding to a similarity parameter, the fixed neighbor zone having a second fixed boundary.

Aspect 17: The non-transitory computer-readable medium of Aspect 16, in which the program code further comprises program code to learn the similarity parameter with machine learning training.

Aspect 18: The non-transitory computer-readable medium of Aspect 16 or 17, in which the similarity parameter comprises a self-attention coefficient.

Aspect 19: The non-transitory computer-readable medium of any of the Aspects 16-18, in which the self-attention coefficient normalizes a relationship between the local machine learning updates of the local subset and the neighbor machine learning updates of the neighbor subset.

Aspect 20: The non-transitory computer-readable medium of any of the Aspects 16-19, in which the relationship comprises an inner product.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A processor-implemented method, comprising:
receiving machine learning model updates from a plurality of clients in a federated learning system;
determining a fixed local zone associated with each of the plurality of clients, the fixed local zone having a first fixed boundary;
updating model weights of a central machine learning model based on local machine learning updates for a local subset of the plurality of clients, the local subset corresponding to the fixed local zone; and
updating the model weights of the central machine learning model based on neighbor machine learning updates for a neighbor subset of the plurality of clients, the neighbor subset corresponding to a fixed neighbor zone that neighbors the fixed local zone, the neighbor machine learning updates having a different weight than the local machine learning updates when updating model weights, a value of the different weight corresponding to a similarity parameter, the fixed neighbor zone having a second fixed boundary.

2. The processor-implemented method of claim 1, further comprising learning the similarity parameter with machine learning training.

3. The processor-implemented method of claim 1, in which the similarity parameter comprises a self-attention coefficient.

4. The processor-implemented method of claim 3, in which the self-attention coefficient normalizes a relationship between the local machine learning updates of the local subset and the neighbor machine learning updates of the neighbor subset.

5. The processor-implemented method of claim 4, in which the relationship comprises an inner product.

6. An apparatus, comprising:
at least one memory; and
at least one processor coupled to the at least one memory, the at least one processor configured to:
receive machine learning model updates from a plurality of clients in a federated learning system;
determine a fixed local zone associated with each of the plurality of clients, the fixed local zone having a first fixed boundary;
update model weights of a central machine learning model based on local machine learning updates for a local subset of the plurality of clients, the local subset corresponding to the fixed local zone; and
update the model weights of the central machine learning model based on neighbor machine learning updates for a neighbor subset of the plurality of clients, the neighbor subset corresponding to a fixed neighbor zone that neighbors the fixed local zone, the neighbor machine learning updates having a different weight than the local machine learning updates when updating model weights, a value of the different weight corresponding to a similarity parameter, the fixed neighbor zone having a second fixed boundary.

7. The apparatus of claim 6, in which the at least one processor is further configured to learn the similarity parameter with machine learning training.

8. The apparatus of claim 6, in which the similarity parameter comprises a self-attention coefficient.

9. The apparatus of claim 8, in which the self-attention coefficient normalizes a relationship between the local machine learning updates of the local subset and the neighbor machine learning updates of the neighbor subset.

10. The apparatus of claim 9, in which the relationship comprises an inner product.

11. An apparatus, comprising:
means for receiving machine learning model updates from a plurality of clients in a federated learning system;
means for determining a fixed local zone associated with each of the plurality of clients, the fixed local zone having a first fixed boundary;
means for updating model weights of a central machine learning model based on local machine learning updates for a local subset of the plurality of clients, the local subset corresponding to the fixed local zone; and
means for updating the model weights of the central machine learning model based on neighbor machine learning updates for a neighbor subset of the plurality of clients, the neighbor subset corresponding to a fixed neighbor zone that neighbors the fixed local zone, the neighbor machine learning updates having a different weight than the local machine learning updates when updating model weights, a value of the different weight corresponding to a similarity parameter, the fixed neighbor zone having a second fixed boundary.

12. The apparatus of claim 11, further comprising means for learning the similarity parameter with machine learning training.

13. The apparatus of claim 11, in which the similarity parameter comprises a self-attention coefficient.

14. The apparatus of claim 13, in which the self-attention coefficient normalizes a relationship between the local machine learning updates of the local subset and the neighbor machine learning updates of the neighbor subset.

15. The apparatus of claim 14, in which the relationship comprises an inner product.

16. A non-transitory computer-readable medium having program code recorded thereon, the program code executed by a processor and comprising:
program code to receive machine learning model updates from a plurality of clients in a federated learning system;
program code to determine a fixed local zone associated with each of the plurality of clients, the fixed local zone having a first fixed boundary;
program code to update model weights of a central machine learning model based on local machine learning updates for a local subset of the plurality of clients, the local subset corresponding to the fixed local zone; and
program code to update the model weights of the central machine learning model based on neighbor machine learning updates for a neighbor subset of the plurality of clients, the neighbor subset corresponding to a fixed neighbor zone that neighbors the fixed local zone, the neighbor machine learning updates having a different weight than the local machine learning updates when updating model weights, a value of the different weight corresponding to a similarity parameter, the fixed neighbor zone having a second fixed boundary.

17. The non-transitory computer-readable medium of claim 16, in which the program code further comprises program code to learn the similarity parameter with machine learning training.

18. The non-transitory computer-readable medium of claim 16, in which the similarity parameter comprises a self-attention coefficient.

19. The non-transitory computer-readable medium of claim 18, in which the self-attention coefficient normalizes a relationship between the local machine learning updates of the local subset and the neighbor machine learning updates of the neighbor subset.

20. The non-transitory computer-readable medium of claim 19, in which the relationship comprises an inner product.
